(19) United States
(12) Patent Application Publication
(10) Pub. No.: US 2017/0097013 A1
(43) Pub. Date: Apr. 6, 2017

(54) Blower Apparatus for an Aerodynamic Fairing Assembly

(71) Applicant: WALL GLOBAL LLC, Franklin, TN (US)

(72) Inventor: Billy Russell Wall, II, Franklin, TN (US)

(21) Appl. No.: 15/385,818

(22) Filed: Dec. 20, 2016

Related U.S. Application Data
(63) Continuation-in-part of application No. 15/115,762.
(60) Provisional application No. 62/009,683, filed on Jun. 9, 2014.

(51) Int. Cl. F04D 29/58; F04D 29/42; F04D 29/28; B62D 35/00; F04D 25/06; F04D 17/16; F04D 29/70

(52) U.S. Cl. CPC F04D 29/5806; F04D 17/16; F04D 29/4226; F04D 29/703; B62D 35/004; F04D 25/0606; F04D 29/281

(57) ABSTRACT

The blower apparatus includes a fan unit and an electrical motor enclosed in a blower housing, which is configured to have a large rectangular fan box, a cylindrical motor guard and vent cap. The fan unit is disposed within the fan box and the electric motor is disposed within the motor guard which extends from the fan box and is covered by the vent cap. The sidewall of the vent cap overlies and is spaced from the sidewall of the motor guard forming an outer air passage around the motor guard. Similarly, the sidewall of the motor guard is spaced from the motor forming an inner air passage around the motor. The configuration of the blower housing allows ambient inlet air to enter the blower housing between the sidewalls of the vent cap and motor guard and then pass around the motor before entering the fan unit.

This application is a continuation-in-part of U.S. patent application Ser. No. 15/115,762 filed Aug. 1, 2016, that claims the benefit of PCT Patent Application, Ser. No. PCT/US15/034737 filed Jun. 8, 2015, which claims the benefit of U.S. Provisional Patent Application, Ser. No. 62/009,683 filed Jun. 9, 2014, the disclosures of which are hereby incorporated by reference.

This invention relates to a blower apparatus for supplying a continuous airflow to inflatable panels used in an aerodynamic fairing assembly for tractor-trailers.

### BACKGROUND AND SUMMARY OF THE INVENTION

Aerodynamic fairing assemblies, such as the ones developed and manufactured by Wall Global, LLC. of Franklin, Tenn., use inflatable wall panels that automatically deploy and retract at certain speeds to cover and enclose the space between the tractor truck and connected trailers. This type of aerodynamic fairing assembly significantly improves the aerodynamics of long haul tractor-trailers, which increases fuel economy and vehicle stability. This type of aerodynamic fairing assemblies use blowers that provide a continuous airflow to the inflatable panels during deployment to maintain the rigidity and structural integrity of the panel regardless of ambient temperature or air pressure. Because the blowers in these fairing assemblies do not simply inflate the wall panels, but provide continuous airflow to the panels to keep them properly inflated while deployed, the electric motors driving the blower fans run for extended periods of time. As a result of the extended runtimes, the motors are subject to over heating, which can cause system failures on the road.

The blower apparatus of this invention is designed and intended to be used in an aerodynamic fairing assembly, such as those developed by Wall Global, where the blower apparatus provides a continuous airflow to deploy inflatable wall panels and keep them inflated while deployed. The blower includes a fan unit and an electrical motor enclosed in a blower housing. The blower housing is configured to have a large rectangular fan box, a cylindrical motor guard and vent cap. The fan unit is disposed within the fan box and the electric motor is disposed within the motor guard which extends from the fan box and is enclosed by the vent cap. The sidewall of the vent cap overlies and is spaced from the sidewall of the motor guard forming an outer air passage around the motor guard. Similarly, the sidewall of the motor guard is spaced from the motor forming an inner air passage around the motor. The configuration of the blower housing allows ambient inlet air to enter the blower housing between the sidewalls of the vent cap and motor guard and then pass around the motor before entering the fan unit. Venting the inlet airflow through the motor guard and around the motor helps cool the motor, reducing motor failure and improving motor efficiency. In addition, the thermal energy transferred from the motor heats the inlet air and helps reduce ice build up on the inflated wall panels.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention.

The drawings illustrate the present invention, in which:

FIG. 1 is a perspective view of an exemplary embodiment of the blower apparatus of this invention used in an aerodynamic fairing assembly;

FIG. 2 is a rear perspective partial exploded view of a tractor truck and the fairing assembly of FIG. 1 with the inflatable wall panels retracted; and

FIG. 3 is a rear perspective partial exploded view of a tractor truck and the fairing assembly of FIG. 1 with the inflatable wall panels deployed.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

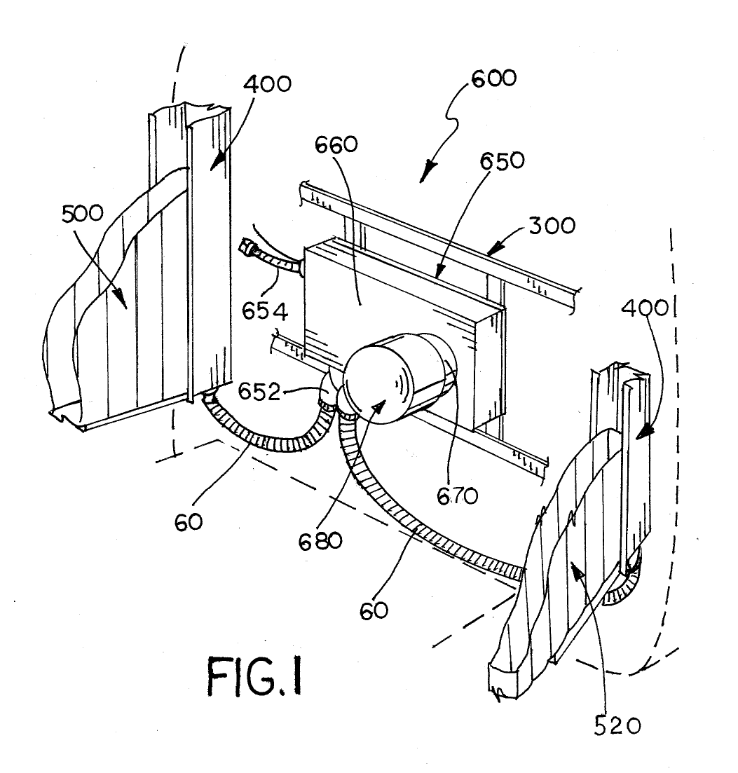

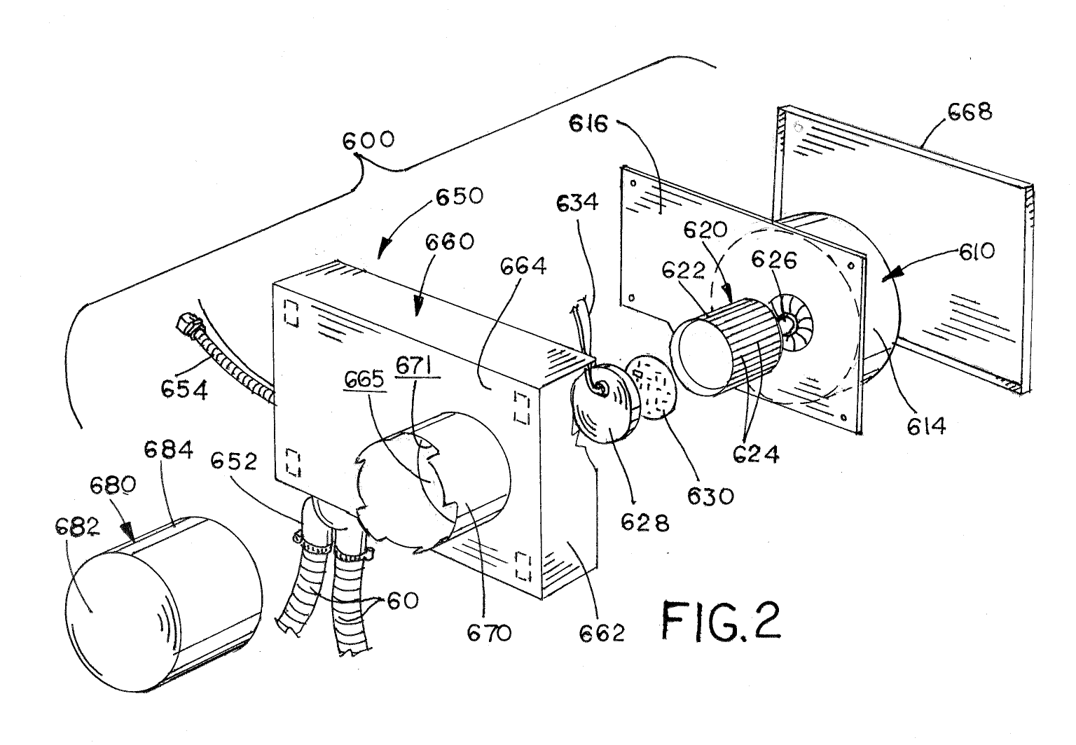

Referring now to the drawings, FIGS. 1-3 illustrate an exemplary embodiment of the blower apparatus or simply “blower” of this invention, which is designated generally as reference numeral 600. Blower 600 is specifically designed and intended to be used in an aerodynamic fairing assembly, such as those developed by Wall Global, where the blower provides a continuous airflow to deploy inflatable wall panels 500 and keep them inflated while deployed. Blower 600 mounts to a support structure 300 affixed to the back of a tractor cab (not shown) and carries a pair of panel housings 400 and the inflatable panels 500 that inflate to deploy from the panels. Inflatable panels 500 deploy outward from separate panel housings 400 and form an airfoil or side fairing wall, which cover or enclose the gaps between the tractor truck and trailer (also not shown). Blower 600 provides high velocity airflow that quickly inflates panels 500 deploying them from panel housings 400 and maintaining the air pressure within the panels at pressures sufficient to provide a sturdy fairing wall structure.

As shown, blower 600 includes a fan unit 610 and an electrical motor 620 enclosed in a blower housing 650. Fan unit 610 is operatively connected to a dual air port 652 that extends from blower housing 650. Motor 620 is operatively connected to an electrical wiring harness 654 that also extends from blower housing 650.

Fan unit 610 is a centrifugal (“blower”) fan of conventional design. Generally, centrifugal fans are selected for blower 600 because they are sturdy, quiet, reliable, and capable of operating over a wide range of conditions. Fan unit 610 includes a rotating impeller 612 enclosed in an impeller housing 614. Fan unit 610 displaces air radially, changing the direction (typically by 90°) of the airflow. Impeller housing 614 has an inlet collar 618 through which inlet air enters the center of impeller 612 and an outlet port (not shown) through which the output airflow is vented. Impeller housing 614 is mounted to a support plate 116 that is used to secure fan unit 610 within blower housing 650.

Fan unit 610 is driven by an electric motor 120. Motor 620 is generally of conventional design and includes a rotor and stator (not shown) disposed within a cast metal motor casing 622. Motor casing 622 is cast to have a plurality of radially extending external ribs 24 that function as heat sinks for the motor. Motor 620 has a drive shaft that extends through the charge collar and is connected to the center hub of impeller 612.

The control logic and circuitry that controls the operation and various functions of blower 600 as part of the aerodynamic fairing system is contained on a single circuit board 630 disposed within motor casing 622. Circuit board 630 carries a GPS module, CPU processor, memory, I/O interface components, as well as, the other electrical and electronic components that comprise the control circuitry. Circuit board 630 is seated within the distal end of motor casing 622 and enclosed by a cover plate 628 that is affixed to the motor casing. Wire leads 634 extend from circuit board 630 and pass through a connector fitting in cover plate 628. Wire leads 634 extend through blower housing 650 and are bundled to form a wiring harness 554 that extends from blower housing 550. Incorporating the control logic and circuitry for the entire aerodynamic fairing system on a single board localized within the blower motor casing with a single wiring harness eliminates the need for multiple control modules with separate circuit boards and components with multiple wiring connections.

Blower housing 650 is typically a metal enclosure constructed from sheet metal, but may be molded or otherwise formed from a suitable polymer plastic. Blower housing 550 is configured to have a large rectangular fan box 660 with a removable back cover 668 and a cylindrical motor guard 670. Fan box 660 has four end walls 662 and a flat front panel 664 with open back side. Blower housing 550 includes a rectangular fan box 660 and a removable back cover 668. Fan unit 610 is mounted within fan box 660. Mounting plate 616 of fan unit 610 is affixed to raised studs formed on the inside of front panel 664. Front panel 664 has a central opening 665, which aligns with charging collar 618 and air inlet of fan unit 610. Motor guard 670 is a cylindrical wall extending outward from front panel 664 around opening 665. Motor guard 670 has four vent openings 671 cut radially around its distal edge. Blower housing 650 also includes a vent cap 680 welded concentrically over motor guard 670. Vent cap 680 has a circular end wall 682 and a cylindrical sidewall 684. End wall 682 is welded or bonded to the end of motor guard 670.

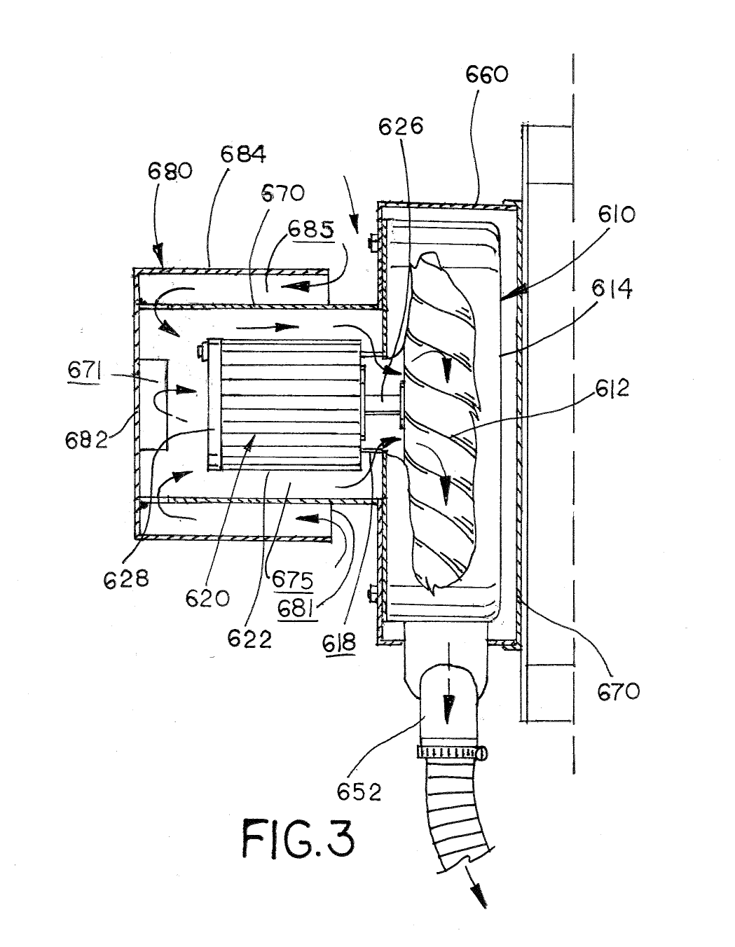

As shown in FIG. 3, cap sidewall 684 overlies and is spaced from the sidewall of motor guard 670 forming an outer air passage 685 around the motor guard. Similarly, the sidewall of motor guard 670 is spaced from motor casing 622 forming an inner air passage 675 around motor 620. Ambient inlet airflow enters blower housing 650 at the annular opening 681 between vent cap 680 and the base of motor guard 670. The inlet air flow travels through air passage 685 and passes through vent openings 671 into the interior of motor guard 670. The inlet airflow passes through air passage 675 around motor 620 and enters fan unit 610 through fan inlet collar 618. Rotation of impeller 612 forces the airflow outward radially within the impeller housing creating a high velocity output airflow that is vented from fan unit 610 through the dual output port 652. Air hoses 60 connect output port 652 to inflatable wall panels 500.

The configuration of blower housing 650 provides several advantages for the blower of this invention. Venting the inlet airflow through motor housing 670 around motor 620 helps cool motor 620, reducing motor failure and improving motor efficiency. Thermal energy dissipated from the operation of motor 620 through heat sinks 624 is transferred into the inlet air, which cools the motor but also heats the inlet airflow. Heating the inlet airflow helps reduce the chance of ice build up on inflatable wall panels 500. In cold environments, inflating the wall panels with a continuous airflow that has a temperature above the ambient air temperature, helps prevent ice from forming on the panels. By venting inlet airflow around motor 620 before entering fan unit 610, the inlet air flow is heated above the ambient air temperature using the thermal energy dissipated from the motor. In addition, venting the inlet airflow back and forth through air passages 685 and 675 and through vent openings 673 helps prevent rain, snow, ice and road debris from being ingested into fan unit 610. The concentric overlapping configuration of motor guard 670 and vent cap 680 eliminates the need for filters and screens at the inlet of fan unit 610 to prevent water and debris from obstructing and damaging the fan unit.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A blower apparatus for use in an aerodynamic fairing assembly for a tractor-trailer where the blower apparatus provides a continuous output airflow into an aerodynamic wall panel that keeps the wall panel inflated,
the blower apparatus comprises:
a fan unit for generating the continuous output airflow from an inlet airflow to inflate the wall panel, the fan unit includes an impeller housing and a rotatable impeller disposed within the impeller housing;
a motor operatively connected to the fan unit to turn the impeller; and
a blower housing enclosing the fan unit and motor, the blower housing includes the fan box and a motor guard extending from the fan box, the fan unit disposed in the fan box, the motor disposed within the motor guard, the motor guard includes a cylindrical guard sidewall, the motor interposed between and spaced from the guard sidewall to form an airflow passage around the motor, such that the inlet airflow passes over and around the motor to cool the motor and heat the inlet airflow.

2. The blower apparatus of claim 1 wherein the blower housing also includes a vent cap mounted to and covering the motor guard.

3. The blower apparatus of claim 2 wherein the vent cap includes a cap side wall overlying the guard sidewall and spaced therefrom to define a second airflow passage, such that the inlet airflow passes through the second airflow passage before entering the first airflow passage.

4. The blower apparatus of claim 3 wherein the guard sidewall has a plurality of openings therein for allowing airflow to pass from the second airflow passage into the first airflow passage.

5. The blower apparatus of claim 3 wherein the airflow through the first airflow passage is in one direction and the airflow through the second passage is in the opposite direction.

6. the blower apparutus of claim 1 wherein the motor includes a motor casing and control circuitry for controlling the operation of the blower apparatus mounted within the motor casing.

7. The blower apparatus of claim 1 wherein the motor includes a motor casing having a plurality of heat sinks extending therefrom.
